(19) United States
(12) Patent Application Publication
(10) Pub. No.: US 2010/0032477 A1
(43) Pub. Date: Feb. 11, 2010

(54) Banking transaction tracking

(76) Inventor: James Otis Faulkner, Cambridge, MD (US)

Correspondence Address: Otis Faulkner, 117 Mimosa Dr., Cambridge, MD, 21613, US

(21) Appl. No.: 12/459,726

(22) Filed: Jul. 7, 2009

Related U.S. Application Data
(60) Provisional application No. 61/086,734, filed on Aug. 6, 2008.

(51) Int. Cl. G06Q 40/00

(52) U.S. Cl. 235/379

(57) ABSTRACT

The idea behind this patent filing is to have the ability to track currency. The idea has a use at both the local economy as well as at the federal government level. At the local level, an example of the idea would be a chain store, such as a WAWA or 7-11 chain.

The chain head quarters in most cases are located in a city other than the store location. All daily reports are transmitted to the corp. office at the time of closing or during the next business day.

With this idea, a corp. can pull reports in REAL TIME, know the amount of cash taken in during any given time of the day, and know exactly what amount of currency should be deposited into the bank account.

Another benefit to the home office is the info about the time of day and days of the week the store is doing the most business and will have the info needed to staff that location to support the flow of customers.

At the federal level, governments will have the ability to see where the currency is being deposited, spent, on what products currency is being spent on.

Huge cooperation doing business in the US, makes deposits in tax exempt countries, making that money tax free.

Another reason to track currency is the info the government would have as to money laundering, drug money and money used to support terrorism.

Where is the currency being deposited, by who and who is with drawling that currency? This idea could be used in the war against terrorism, the drug war, tax evasion and a tool to help governments to predict the economic future.

### BACKGROUND OF THE INVENTION

1. Field of the Invention

The present invention relates to a system and method for collecting and processing data obtained from machine readable currency, including paper money. The currency need not be modified to make it useable with the system or method. The system and method may be useful, for example, in the detection of counterfeit currency and in tracking individual pieces of currency, such as a $20 bill, as the currency circulates in commerce.

2. Discussion of the Related Art

The United States Department of the Treasury (the Treasury Department) is responsible for the Treasury of the United States. The Bureau of Engraving and Printing, which is a branch of the Treasury Department, prints all of the paper currency used in the United States. United States paper currency, also referred to as Federal Reserve notes, is printed at the Bureau of Engraving and Printing's facilities in Washington, D.C. and Fort Worth, Tex.

Among the responsibilities of the Treasury Department is the responsibility of investigating and prosecuting persons accused of such crimes as counterfeiting currency. One can imagine that the art counterfeiting paper money has existed as long as, or almost as long as, humankind has used paper currency. The lure of printing one's own wealth, and perhaps the challenge of duplicating, sometimes with near perfection, what is essentially a drawing on paper, overcomes the fact that counterfeiting is illegal and the penalty for indulgence in this vice is severe. In order to forestall counterfeiting, legitimate producers of paper currency, such as the Bureau of Engraving and Printing, have, among other things, increased the complexity of the illustrations shown on the face of the currency, used watermarks in the paper, used special paper, used magnetic ink, embedded security threads into the paper, used micro-printing, and transitioned from monochromatic printing to multicolor printing. Possible methods of the future to thwart counterfeiting include the use of thermochromic inks, inks that change color as viewing angle changes, and holographic images embedded within the paper of the currency. Still, it must be recognized that in their day, each of the present day security measures has in time been compromised by counterfeiters.

One of the simplest and least protected indicia of the legitimacy of any currency worldwide is the serial number printed on each bill. In the United States, no two pieces of paper currency share the same serial number. This is believed to be true for most if not all of the countries of the world. Thus, common denominations of a given design for currency, are identical in all respects except one—each has its own unique serial number. Other indicia of uniqueness maybe added to currency, such as a bar code or the like, but presently, the United States does not use bar coding on its currency.

In the United States, banknotes are produced in sheet form, with multiples of the same denomination of money being printed on each single sheet. The individual banknotes of a given sheet are not serialized until the conclusion of the production process. The sheets are serialized only after extensive quality control inspections have eliminated sheets containing defects. Inspections after serialization may detect defects caused by the serialization process. Banknotes may also be rendered defective as a result of the cutting process. Thus, additional quality control can uncover banknotes that cannot be released for circulation.

The Bureau of Engraving and Printing releases currency without gaps in serialization. Therefore, if a defective bill is serialized and detected, that bill is replaced with a non-defective bill having the same serial number [followed/preceded] by a star. The originally serialized bill is destroyed. In this manner, entire ranges of serial numbers of bills printed and released by the Bureau of Engraving and Printing is known with certainty.

To appear as a legitimate bill, a counterfeit bill must have a serial number imprinted on its face. The serial number on a counterfeit bill will either be one that is duplicated from an existing bill in circulation, or one that is fictional.

Federal Reserve notes are printed in denominations of 1, 2, 5, 10, 20, 50, and 100 Dollars. All Federal Reserve notes, regardless of their denomination, have unique serials numbers. Therefore, there is only one legitimate Federal Reserve note for any given serial number in circulation.

Accordingly, the present invention substantially obviates one or more of the problems due to limitations and disadvantages of the related art.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is schematic diagram of a system in accordance with the invention.

FIG. 2 illustrates a device useful in acquiring data required to perform a method of the invention described herein.

FIG. 3 is a flow diagram of a method in accordance with the invention.

FIG. 4 is an illustration of information that may be present in a database in accordance with an embodiment of the invention.

### DETAILED DESCRIPTION

Reference will now be made in detail to the illustrated embodiments, examples of which are illustrated in the accompanying drawings.

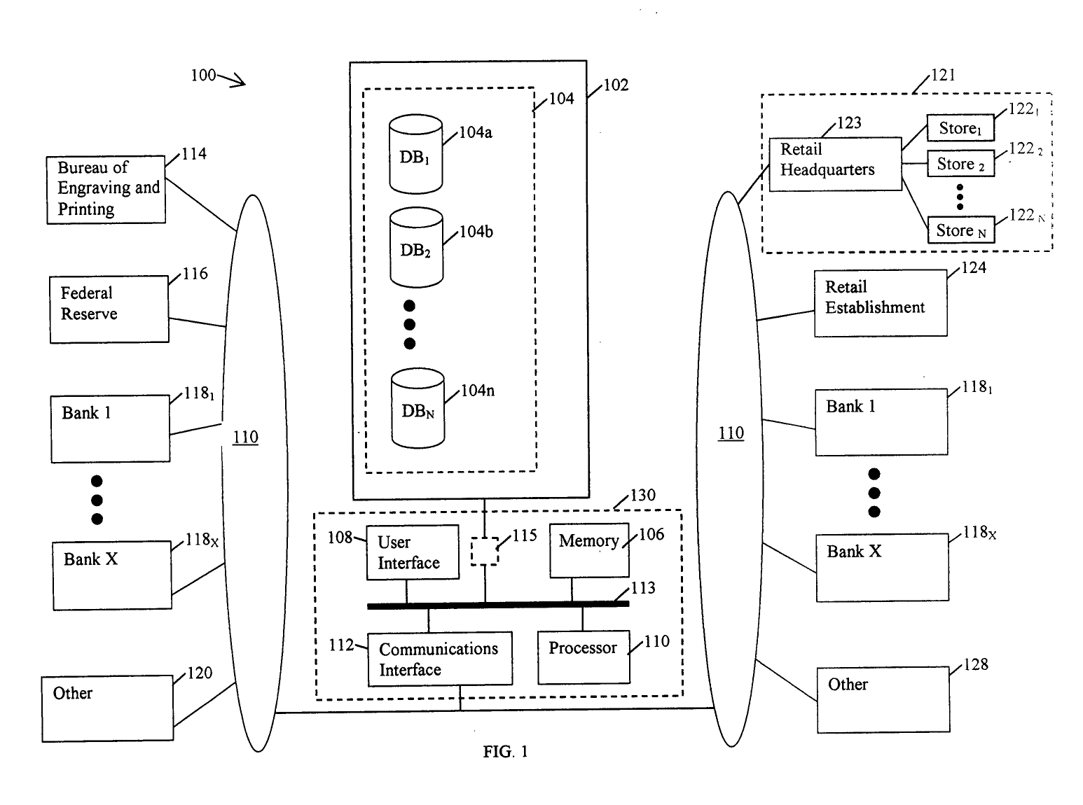

FIG. 1 is schematic diagram of a system 100 in accordance with an embodiment of the invention. The system 100 comprises a central data center 102. The central data center 102 comprises a memory 104 that may be configured as a network of one or more databases 104a, 104b, 104c, etc. The databases 104(a) et seq. can be physically co-located or distributed in multiples of locations. Stored within central data center 102 are data representative of each serial number of each banknote (e.g., Federal Reserve Note) to be tracked by the system 100. The serial numbers include serial numbers of Federal Reserve Notes in storage, in-circulation, destroyed, and unaccounted for.

Examples of Federal Reserve notes in storage are those notes being held in private bank vaults or in United States Treasury or Treasury Department controlled vaults, such as the vaults of the Federal Reserve. Examples of notes in-circulation include those notes that are recognized as being exchanged for goods and services a retail establishments, notes used to pay utility and hospital bills, as well as notes being issued from banks by bank tellers or automated teller machines. Examples of destroyed notes include all notes known to have been shredded by the Federal Reserve at the end of the notes' useful life (which is limited by wear and tear). Examples of notes that are unaccounted for include all notes that do not fall in any other category. For example, an unaccounted for note is one that is known to have been printed by the Bureau of Engraving and Printing, shipped to the Federal Reserve, and subsequently shipped to a bank, however, the serial number of the note is not identified as being in storage, in circulation within a predetermined timeframe, or as being destroyed. Such a note could be in a child's piggy bank or stuffed into a mattress, where it might stay for years before being deposited in a bank account or used in commerce.

A computer 130 may include a memory 106, a user interface 108, which may include a display, keyboard, and mouse. A processor 110 may execute instructions that would exercise the system in its performance of a method in accordance with an embodiment of the invention. The instructions could be stored in memory 106, but could be stored in any memory operationally coupled to the processor, such as memory 104. Also included may be a communications interface 112, which may be coupled, for example, to one or more communication network(s) 110. The communication network(s) 110 may include the Internet, the public switched telephone network, and/or any other communications network. The central data center 102, memory/database 104, memory 106, user interface 108, processor 110, and communications interface 112 may be all operationally coupled via communications bus 113. An interface 115 may also be coupled between central data center 102 and/or memory/database 104 and communications bus 113, if needed.

Providing data to the system 100 are various entities, including the Bureau of Engraving and Printing 114, the Federal Reserve 116, various banks 118₁-118_{X} (where X is an integer) (individually or collectively referred to as bank 118). Each of the exemplary entities 114, 116, 118 may serve as a repository for banknotes and may be referred to herein as banknote storage entities.

As used herein, a banknote is “out-of-circulation” if it is stored in one of the entities that may function as a repository for banknotes. The term “out-of-circulation” is meant to describe the state of the physical banknote itself. In fact, the money represented by the banknotes deposited into, for example, a bank 118 is in a sense re-circulated in the form of, for example, loans to allow bank customers to purchase homes. However, as used herein, a banknote deposited into a bank 118 is “physically” out of circulation until that same banknote is withdrawn from the bank and physically provided to a living entity (i.e., a person) or a fictional entity (e.g., a corporation). In the same sense, a banknote is out of circulation if it is stored in the Bureau of Engraving and Printing, or in the Federal Reserve.

Entities 114, 116, 118 may periodically transmit information to the system 100 for storage in the memory/database 104 of the central data center 102. Transmission may be via communications network 110. Transmitted information may include banknote serial number, banknote value, banknote status (i.e., in-circulation or out-of-circulation), and identifier (if known) of a holder of the banknote.

Information, such as that described above, may also be transmitted to the system 100 from retail entities, such as large retail establishment 121 or small retail establishment 124. Large retail establishment 121 may be comprised of multiple store branches 122₁, 122₂, . . . , 122_{N} (where N is an integer) (collectively or individually referred to herein as branches 122). Information relating to banknotes received or disbursed by branches 122 may be periodically transmitted to the headquarters 123 of the large retail establishment 121. The information collected by headquarters 123 from branches 122 may be periodically transmitted for storage to central data center 102. Likewise, information related to banknotes may be periodically transmitted to central data center 102 from small retail establishments, such as entity 124. Likewise, information related to banknotes may be periodically transmitted to central data center 102 from bank(s) 118. Although not shown, each bank has multiple human and automated tellers. Each of these components of the bank(s) 118 may feed information related to banknotes back to its bank's headquarters. Each of bank(s) 118 headquarters may periodically transmit banknote information for storage in database 104, as described above, for example, in the case of large retail entity 121. Of course, the entities described above are exemplary and are not meant to be exclusive. Other entities 120, 128 are expected to provide information concerning banknotes passing into and out of their cognizance.

As will be understood, the embodiments of the invention described herein will be most effective if all possible entities participated. Nevertheless, even if less than all entities participate, there will still be an improvement in information relating to banknotes and their circulation in commerce. Additionally, as will be understood, the embodiments of the invention described herein will be most effective transmissions of information concerning banknotes are transmitted in real, or near real time. However, periodic transmissions, regardless of their periodicity, will improve the known information relating to banknotes and their circulation in commerce.

As is understood, an exemplary retail entity may include a number of point of sale scanners. Each scanner may be able to optically read the serial number of any given banknote and use optical character recognition software to convert the image of the serial number into an alpha-numeric string of text. The hardware required for such scanning and recognition is known in the art and is not considered to be a part of the invention described herein.

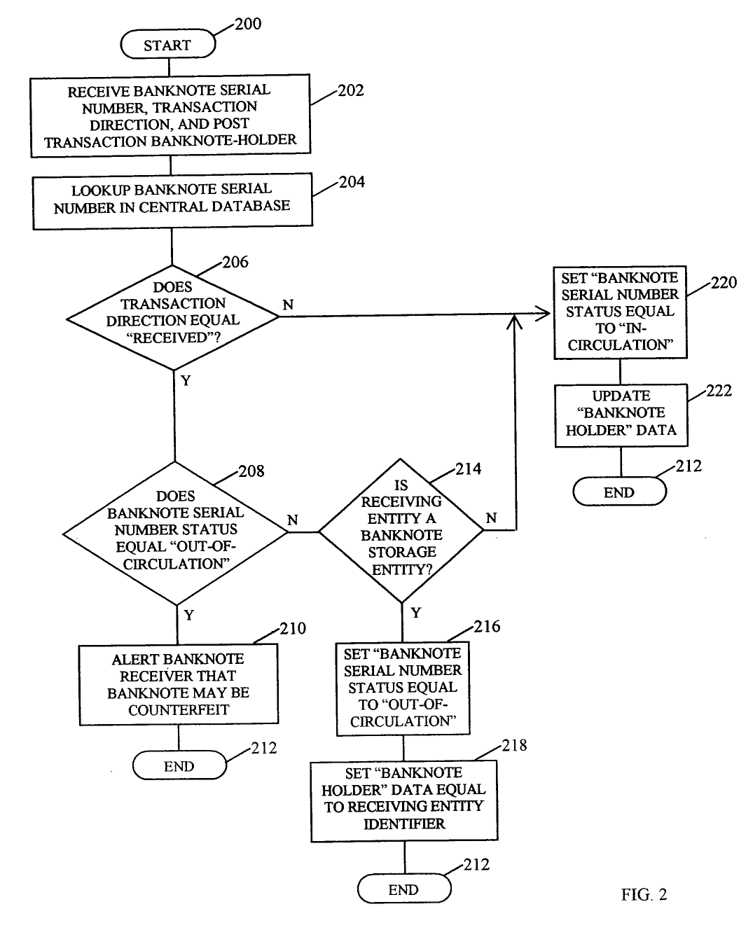

FIG. 2 is a flow diagram of a method in accordance with an embodiment of the invention. The method may start at 200. At 202, a computer 113 of the system 100 in accordance with an embodiment of the invention may receive information related to a banknote serial number, a “transaction direction,” and post-transaction banknote-holder. The transaction direction may indicate whether the entity transmitting the information to the central data center 102 has received or disbursed the banknote. The post-transaction banknote-holder may be the entity, real or constructive, that is in possession of the banknote after the transaction that triggered the transmission of the information to the central data center 102.

At 204, a system in accordance with an embodiment of the invention may lookup the banknote serial number in central data center 102. At 206, the system 100 may determine if the transaction direction is equal to “Received.” If the transaction direction is equal to “Received,” the system may determine, at 208, if the banknote serial number status is presently “out-of-circulation.” If the banknote serial number is presently out-of-circulation, then this means that the banknote identified by the unique banknote serial number is already sitting in storage at either the Bureau of Engraving and Printing, the Federal Reserve, or a bank 118. As such, the banknote could not possibly be used to pay for an item, and could not possibly be part of a deposit into a bank.

At 210, if the banknote serial number status is “out-of-circulation, then the system 100 may alert the entity transmitting the information (i.e., the entity receiving the banknote) that the banknote may be counterfeit. At 212, the method may end.

If, however, at 208, the banknote serial number status is “in-circulation,” (i.e., not out-of-circulation), the system 100 may test to determine if the receiving entity is a banknote storage entity, such as the Federal Reserve, or a bank 118. If the receiving entity is a banknote storage entity, then at 216, the “Banknote Serial Number Status” may be set to “out-of-circulation.”

At 218, the “banknote holder” data may be set to equal the identifier associated with the receiving entity. At 212, the method may end.

If, however, at 206 the transaction direction is not equal to “received” then the banknote is being disbursed by the entity transmitting the information to the central data center 102. In this case, at 220, the banknote serial number identifier may be set to equal “in-circulation,” because the banknote is being disbursed to an entity that will presumably be using it in commerce, for example to purchase food or pay rent. Likewise, at 214, if the receiving entity is not a banknote storage entity, then again, the banknote is being disbursed to an entity that will presumably be using it in commerce.

At 222, the banknote holder data may be updated. In the event that the banknote is being disbursed from a bank, or other entity that records the name or identity of the entity to whom the disbursement is being made, the banknote holder data may be made equal to the name of the account holder. If, however the banknote is merely being passed to a customer as change (as may be the case when the entity transmitting the information is a retailer), then the banknote holder data may be set to “unidentified” or the like. At 212, the method may end.

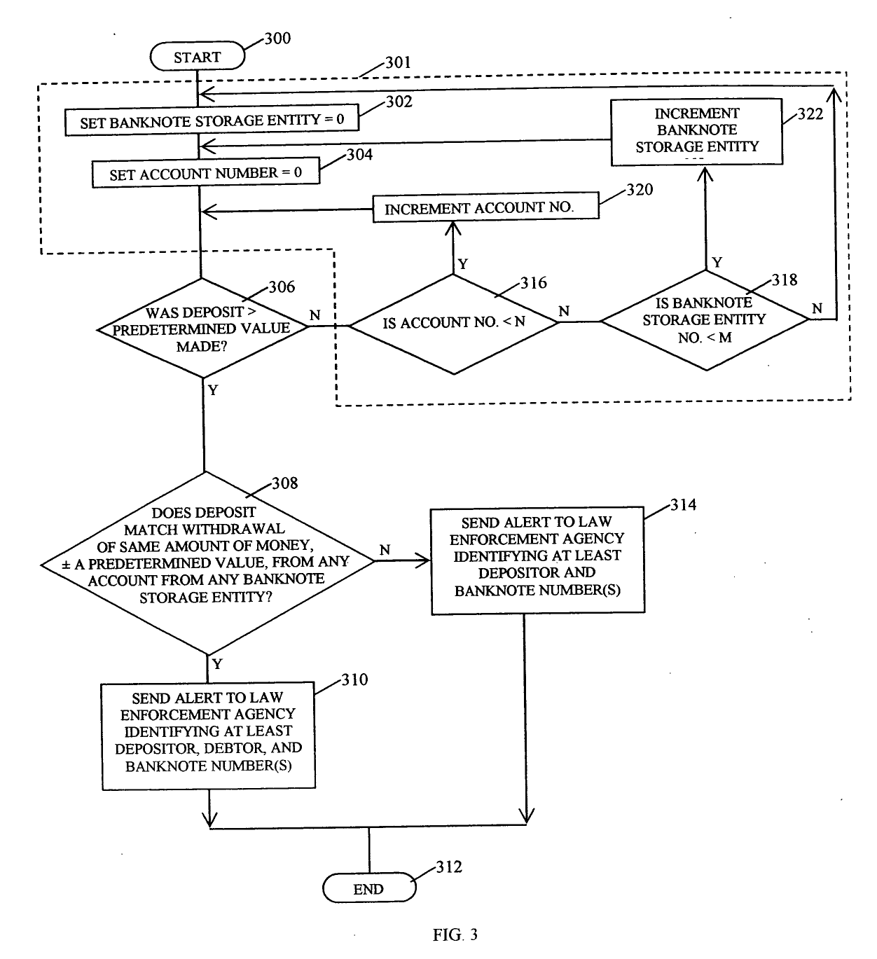

FIG. 3 is another method in accordance with an embodiment of the invention. At 300, the method may begin. At 301, a series of steps may be implemented to ensure that the method of the embodiment disclosed herein is performed on every account of every banknote storage entity. Of course, other methodologies to ensure that the method is performed on every account of every banknote storage entity are within the scope of the invention. By way of example, at 302, the banknote storage entity identifier is set to the first defined entity. At 304, the account number of the banknote storage entity is set to the first defined account of that entity. If the first test, at 306, is negative, then at 316, if the account number is less than the maximum number of accounts held by the banknote storage entity, the account number is incremented and the test, at 306, is again tested. If, at 316, the maximum number of accounts is reached, then at 318 a test is performed to determine if all of the banknote storage entities have been tested. If less than all of the banknote storage entities were tested, then the banknote storage entity number is incremented at 322, the account number for the newest banknote storage entity is set to the first account number for that entity, and the process repeats itself. If, at 318, all M banknote storage entities and their accounts have been tested, then the method returns to 302, where the process may begin anew.

Meanwhile, at 306, if for any given account of any given banknote storage entity, a deposit greater than a predetermined value (e.g., >$10,000) is made, then at 308 the system may determine if a withdrawal of the same amount, plus or minus a predefined amount, was made from any account from any banknote storage entity. If such a withdrawal was made, then, at 310, the system 100 may send an alert to an appropriate law enforcement agency. The alert may at least identify the depositor, disbursement recipient, and banknote number(s) involved. If, however, at 308, there is not withdrawal of approximately the same amount of money from any account of any banknote storage entity (within a predetermined time period with respect to the deposit), then, at 314, the system 100 may send an alert to an appropriate law enforcement agency. The alert may at least identify the depositor and banknote number(s) involved. Subsequent to 310 or 314, the method may end at 312.

The system 100 may also receive information related to banknotes from foreign markets and foreign exchanges. The inclusion of foreign transactions involving U.S. banknotes may provide the Department of Treasury with greater insight into how much U.S. currency is abroad and how it flows in worldwide commerce. A system 100 in accordance with the embodiments described herein may permit the Department of Treasury to track and monitor U.S. banknotes both domestically and in foreign markets.

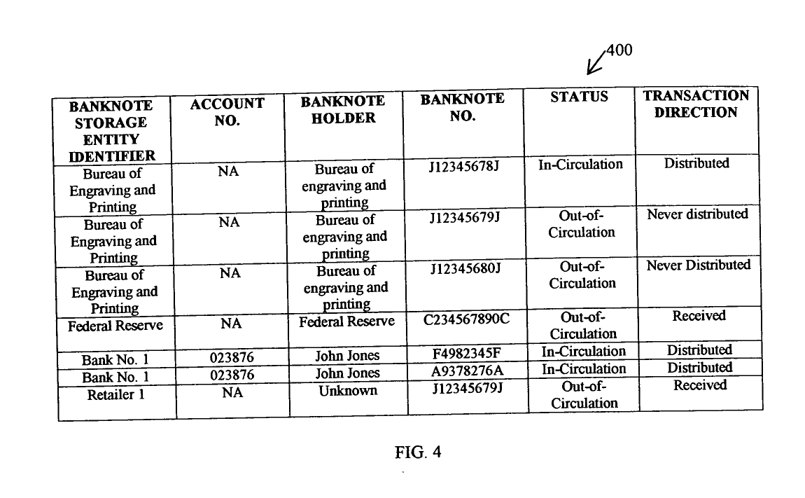

FIG. 4 is an example of data that may be present in a database, such as database 104, in accordance with an embodiment of the invention. The simplified exemplary database 400 may include data related to Banknote-Storage-Entity Identifier, “Account No.,” “Banknote Holder Name/Identifier,” “Banknote No. Status,” and “Transaction Direction,” all as described above with reference to FIG. 1.

The machine readable code may be applied to any type of monetary system. For example, the machine readable code could be used on checks, stocks, bonds, titles, deeds, certificates, legal tender, credit cards, and any other similarly issued medium of exchange having monetary value. It is recognized that the respective checks, stocks, titles, deeds, certificates, legal tender, credit cards, and any other similarly issued medium of exchange having monetary value may be issued by Federal and/or Local governments, businesses, and the private sector. In addition, the machine readable code would make these important financial items traceable.

The machine readable code with embedded data may also be applied to a number of government issued programs, such as Social Security checks, food Stamp programs, welfare programs, disaster relief programs, and living assistance programs. The machine readable code with embedded data would give an entity, such as the U.S. government, another means by which to track, monitor, and enforce a program to ensure that it complies with the appropriated rules and regulations. For example, a system and method implementing a machine readable code with embedded data would provide the entity, which is accountable for the program, with a means to track any compensation or funds that may be lost, stolen, or received by ineligible candidates. The machine readable code with embedded data would thus advantageously serve as a tool that would help protect the integrity of a number of programs.

Illustrating another example of the machine readable code with embedded data, an instance in which a barcode is applied to a debit card. The debit card may comprise any authorized and/or approved monetary value. Continued use of the debit card may occur until face value is spent. However, the debit card is designed such that the value of the card may be increased and/or decreased at any time in accordance with authorized deposits and/or withdrawals. For example, an individual's paycheck, in part or in whole, may be deposited onto the card. In addition, the card may be issued by any authorized entity, such as banks, stores, and/or employers.

Such a dynamic application of the machine readable code on a debit card would facilitate many monetary transactions and would benefit a number of entities. As example, consider the perspective of a retailer. In case, by implementing the aforementioned debit card, the amount of currency, which would be directly counted and/or handled by retailers, would be reduced with increased use of the herein disclosed debit card. Such a reduction in the manual counting and/or handling of currency would result in a time-saving benefit for the retailer. In addition, it may also lessen the amount of coins needed by a retailer to make change and operate a business. Mistakes associated with manual counting and/or handling of currency by retailers would be lessened. In addition, since debit card transactions would enable retailers to reduce the amount of currency, which is being directly handled, there would be less employee thefts thereof.

Additional benefits of a machine readable code on a debit card would also be experienced by, for example, the U.S. Department of Treasury. In this case, the U.S. Department of Treasury would be able to save a significant amount of money by reducing the amount of bills to be printed and the amount of coins to be manufactured. Savings would also result in the materials and resources needed to print bills and manufacture coins. Implementing the aforementioned debit card system would also enable the U.S. Department of Treasury to save significant amount of money by reducing the amount of resources and time associated with counting, tracking, maintaining, and transporting dollars and coins.

In this exemplary case, the debit card's embedded data within the machine readable code may comprise any information that would correctly identify the current monetary amount, which is available on the card. Any information that is necessary for transaction may be read from and/or accessed via the machine readable code with embedded data.

In general, the machine readable code having embedded data comprises a secure design that may be read by any authorized apparatus. These features of the machine readable code is irrespective of the type of monetary medium (e.g., currency or debit card) to which it is applied. The machine readable code having embedded data may be visible, hidden, or not readily visible on the currency. The machine readable code may be implemented in any format that may be read and/or captured by an authorized machine readable currency apparatus. The machine readable code may be encrypted and/or encoded. The machine readable code may be linear, 2D, or any type. The machine readable code may be continuous and/or discrete. As aforementioned, the machine readable code should be designed such that it is secure, but readable by authorized apparatuses.

It will be apparent to those skilled in the art that various modifications and variation can be made in the present invention without departing from the spirit or scope of the invention. For example, the herein disclosed machine readable currency is not limited to U.S. currency, but may be applied to any system that relies upon a currency system having at least some portion of that currency system identified by unique identifiers, such as a serial number. Thus, it is intended that the present invention cover the modifications and variations of this Invention provided they come within the scope of the appended claims and their equivalents.

What is claimed is:

1. A method of banking transaction tracking, comprising:
receiving transaction data from a plurality of banks;
parsing the transaction data to an individual account level;
storing in a database, on the individual account level, the deposit transaction data, wherein the transaction data comprises:
a depository bank name,
a depository bank account number,
an amount deposited,
a unique identifier corresponding to each of a plurality of cash or cash equivalent instruments received in the deposit.

2. The method of claim 1, wherein the unique identifier is derived from optical scanning, magnetic scanning, radio frequency scanning.

3. The method of claim 2, wherein optical scanning includes optical scanning of a barcode and optical scanning of printed alphanumeric serial numbers.

4. The method of claim 1 further comprising:
storing in the database, on the individual account level, transfer transaction data, wherein the transfer transaction data comprises:
a transferor bank name,
a transferor bank account number,
a transferee bank name,
a transferee account number,
an amount transferred,
a unique identifier corresponding to each of the plurality of cash or cash equivalent instruments transferred from the transferor bank to the transferee bank.

5. The method of claim 1, further comprising:
storing in the database, on the individual account level, withdrawal transaction data, wherein the withdrawal transaction data comprises:
a providing bank name,
a providing bank account number,
an amount withdrawn,
a unique identifier corresponding to each of a plurality of cash or cash equivalent instruments provided in the withdrawal.

6. The method of claim 1, wherein cash comprises: legal tender including U.S. currency or foreign currency.

7. The method of claim 1, wherein the cash equivalent comprises: a check, a bond, a money order, an electronic receipt, or an electronic payment.

8. The method of claim 1, wherein account number identifies account owner name and account owner social security number or Federal ID number.

9. The method of claim 1, wherein the total amount can be stored as a function of total cash, total checks, and total non-check cash equivalents.

10. The method of claim 5, further comprising correlating one or more parameters of the deposit, withdrawal, and transfer transaction data to identify an occurrence of a predefined correlation result.

11. The method of claim 10, wherein identification of the occurrence of the predefined correlation result causes a transmission of a signal to a predetermined location.

12. The method of claim 11, wherein the signal includes data relating to the deposit, withdrawal, and transfer transaction data whose correlation resulted in the occurrence of the predefined correlation result.
